(19) United States
(12) Patent Application Publication
(10) Pub. No.: US 2005/0023786 A1
(43) Pub. Date: Feb. 3, 2005

(54) Cart for use with electronic device

(75) Inventor: Paul Delmerico, Winchester, VA (US)

Correspondence Address: FOLEY AND LARDNER;SUITE 500, 3000 K STREET NW, WASHINGTON, DC, 20007, US

(73) Assignee: Rubbermaid Commercial Products LLC

(21) Appl. No.: 10/631,962

(22) Filed: Aug. 1, 2003

(51) Int. Cl. B62B 3/04

(52) U.S. Cl. 280/79.11

(57) ABSTRACT

A cart for an electronic device includes a platform configured to support the electronic device and a cord-retaining portion configured to retain a power cord of the electronic device. The cord-retaining portion includes a first opening that extends in a first direction substantially toward a mid-portion of the cart and a second opening that extends away from the first opening in a second direction that is different from the first direction.

### BACKGROUND OF THE INVENTION

1. Field of the Invention

The present invention relates to a cart and, more particularly, to a cart that can be used to carry an electronic device.

2. Description of Related Art

Carts are often used to carry electronic devices. For example, a wheeled cart may be used to transport audio/visual equipment, such as a television, a VCR, a DVD player, and/or a projector, to a classroom. Often the cart will also be used to hold the audio/visual equipment when it is used in the classroom.

In such carts, it may be difficult to organize the power cords that connect the electronic devices to a power source. Often the cords will hang loosely over the edges of the cart. In this state the cords are prone to being caught on objects as the cart is transported. Also, the loose cords look disorderly.

Conventional carts may not prevent the electronic devices from shifting during transport. Thus, the electronic devices may be damaged during transport.

Conventional carts often do not provide storage for items other than the electronic devices.

### SUMMARY OF THE INVENTION

An aspect of the present invention relates to a cart for an electronic device. The cart includes a platform configured to support an electronic device, and a cord-retaining portion configured to retain a power cord of the electronic device. The cord-retaining portion includes a first opening that extends in a first direction substantially toward a mid-portion of the cart and a second opening that extends away from the first opening in a second direction that is different from the first direction.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate preferred embodiments of the invention and together with the description, serve to explain principles of the invention.

FIG. 1 is a perspective view of a first embodiment of a cart according to the present invention.

FIG. 2 is a partial perspective view of the cart of FIG. 1.

FIG. 3 is a perspective view of a platform of the cart of FIG. 1.

FIG. 4 is a plan view of the platform of the cart of FIG. 1.

FIG. 5 is a perspective view of cord-wrapping portion that can be provided on the cart of FIG. 1.

FIG. 6 is a perspective view of the cart of FIG. 1 with a tray.

FIG. 7 is a perspective view of a second embodiment of a cart according to the present invention.

### DETAILED DESCRIPTION OF THE PREFERRED EMBODIMENTS

Reference will now be made in detail to presently preferred embodiments of the invention, examples of which are illustrated in the accompanying drawings. An effort has been made to use the same reference numbers throughout the drawings to refer to the same or like parts.

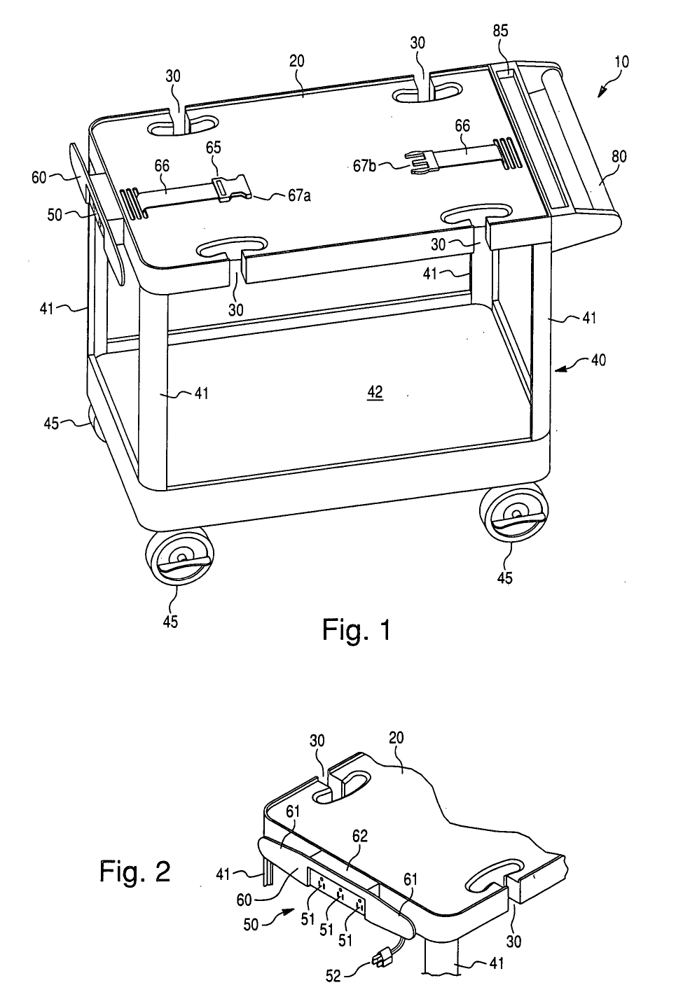

FIGS. 1 to 4 show a first preferred embodiment of a cart 10 according to the present invention. The cart 10 is intended to support one or more electronic devices (not shown). In this embodiment, the cart 10 includes a platform 20 and multiple cord retaining portions 30.

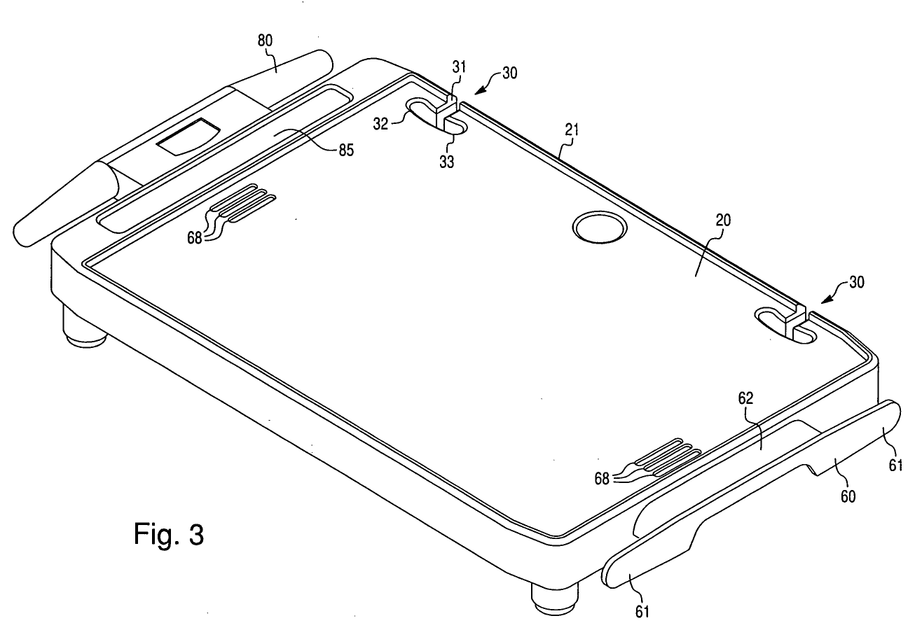

The platform 20 is configured to support an electronic device. Preferably the platform 20 is a substantially flat member. It can be provided with a lip 21 (see FIG. 3) around its periphery to assist in maintaining items on the platform 20. The platform 20 preferably is formed from plastic by a conventional technique, such as injection molding, a structural web process, or a structural foam process. It could, however, be formed of another material, such as metal.

A support 40 can be provided for at least partially supporting the platform 20. The support 40 can include legs 41 and a base 42.

Rolling members 45 also can be provided to at least partially moveably support the platform 20. The rolling members 45 can be conventional pivoting wheel structures, and preferably have conventional braking structures.

The cord retaining portions 30 are configured to retain one or more power cords of the electronic device(s) supported on the platform 20. Each of the cord retaining portions 30 preferably have the same configuration. Thus, only one such cord retaining portion 30 will be described in detail. The cord-retaining portion 30 in this preferred embodiment is configured such that a power cord can be inserted in the cord-retaining portion 30 but will be inhibited from dislodging from the cord-retaining portion 30.

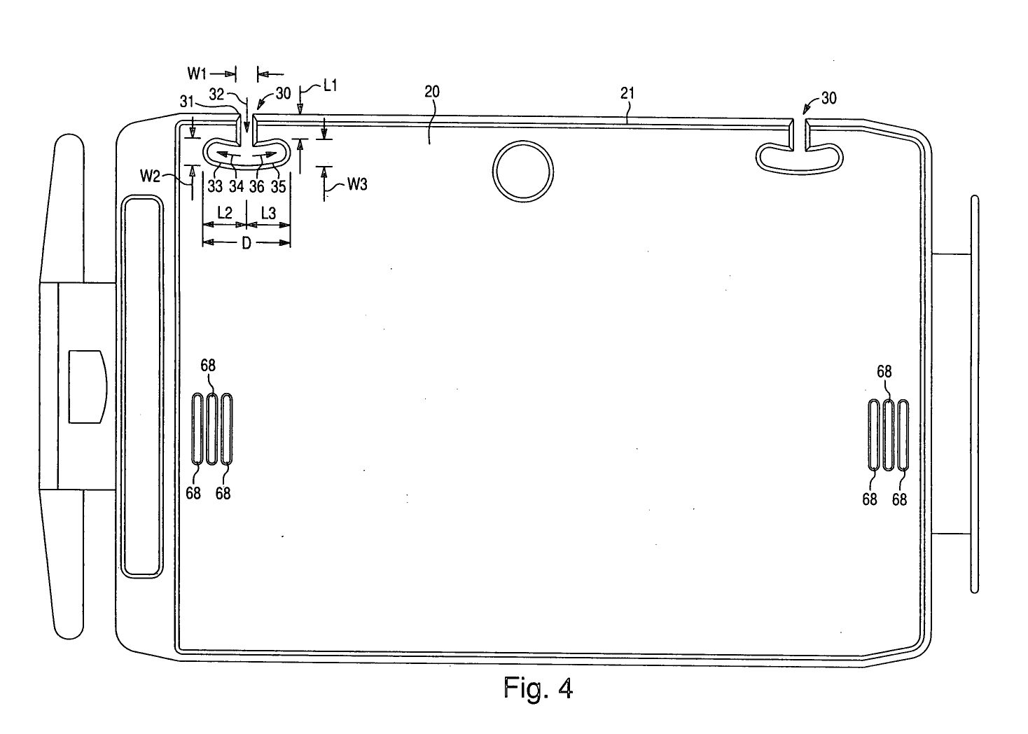

As shown in FIGS. 3 and 4, the cord-retaining portion 30 preferably includes a first opening 31 that extends in a first direction 32 substantially toward a mid-portion of the cart 10. The first opening 31 preferably is a first slot having a length L1 (e.g., approximately 0.625 inches) and a width W1 (e.g., approximately 0.625 inches). The length L1 preferably approximately the same size as the width W1.

The cord-retaining portion 30 also includes a second opening 33 that extends away from the first opening 31 in a second direction 34 that is different from the first direction 32. In this preferred embodiment, the second direction 34 is substantially perpendicular to the first direction 32. The second opening 33 preferably is a second slot having a length L2 (e.g., approximately 1.438 inches) and a width W2 (e.g., approximately 0.813 inches). The length L2 preferably is greater than the width W2.

The cord-retaining portion 30 also includes a third opening 35 that extends away from the first opening 31 in a third direction 36 that is different from the first direction 32. Preferably, the third direction 36 is substantially perpendicular to the first direction 32. Even more preferably, the third direction 36 is substantially opposite to the second direction 34. The third opening 35 preferably is a second slot having a length L3 (e.g., approximately 1.438 inches) and a width W3 (e.g., approximately 0.813 inches). The length L3 preferably is greater than the width W3.

In this preferred embodiment, the second opening 33 and the third opening 35 form an opening for retaining cords. Preferably the opening has a substantially kidney bean shape, which has been found to be useful in retaining cords. In this preferred embodiment, a distance D from a side of the second opening 33 to a side of the third opening 35 is greater than the width W1 of the first opening 31. It is preferred that this distance D be at least two times greater than the width W1 of the first opening 31.

It is preferred that the cord-retaining portion 30 be an integral part of the platform 20. In other words, the cord-retaining portion 30 can be an opening formed or provided in the platform 20.

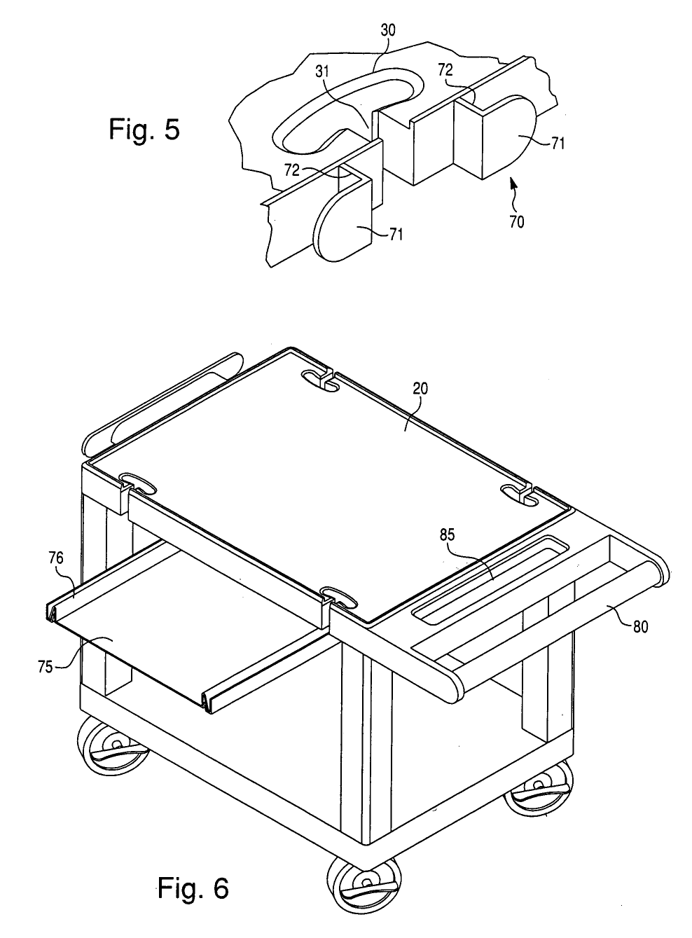

A cord-wrapping portion 70 can be disposed adjacent the first opening 31 of the cord-retaining portion 30, as shown in FIG. 5. The cord-wrapping portion 70 can be configured to retain a power cord wrapped about the cord-wrapping portion 70. For example, the cord-wrapping portion 70 can include two wings 71 and two bases 72. The cord is wrapped around the bases 72 and maintained laterally in position by the wings 71. Preferably the cord-wrapping portion 70 is integral with the platform 20.

The cart 10 can include a power strip 50 (see FIG. 2). The power strip 50 can include multiple outlets 51 and a power cord 52.

The cart 10 also can include a cord-wrapping portion 60. The cord-wrapping portion 60 preferably is disposed about the power strip 50. The cord-wrapping portion 60 is configured to retain the power cord 52 when the power cord 52 is wrapped about the cord-wrapping portion 60. For example, the cord-wrapping portion 60 can include two wings 61 and a base 62. Preferably the cord-wrapping portion 60 is integral with the platform 20.

The cart 10 also can include a restraint 65 for inhibiting movement of an electronic device disposed on the platform 20. The restraint can include a strap 66. Buckle portions 67a and 67b can be mounted on the strap 66. The buckle portions 67a and 67b can be conventional plastic members. The strap 66 preferably extends through slots 68 (see FIGS. 3 and 4). Part of the strap 66 extends over the platform 20 and part of the strap 66 extends under the platform 20. Structure, such as a T shape sewn into the strap 66, can be provided on the ends to of the strap 66 to prevent those ends from falling through the slots 68.

A tray 75 also can be slidably mounted to extend from the platform 20, as shown in FIG. 6. The tray 75 can be mounted to the platform 20 by conventional hardware such that the tray 75 can be slid under the platform 20 and pulled from underneath the platform 20 when needed for use. The hardware can be, for example, ball bearing drawer slides. The tray 75 can be used to hold, for example, a laptop computer. A ridge 76 can be provided on the side of the tray 75 to assist in maintaining items on the tray 75.

A handle 80 can be provided on the platform 20. Preferably the handle 80 is integral with the platform 20.

Furthermore, a holder 85 can be provided between the handle 80 and the platform 20. The holder 85 can be used to hold, for example, pens, pencils, and markers.

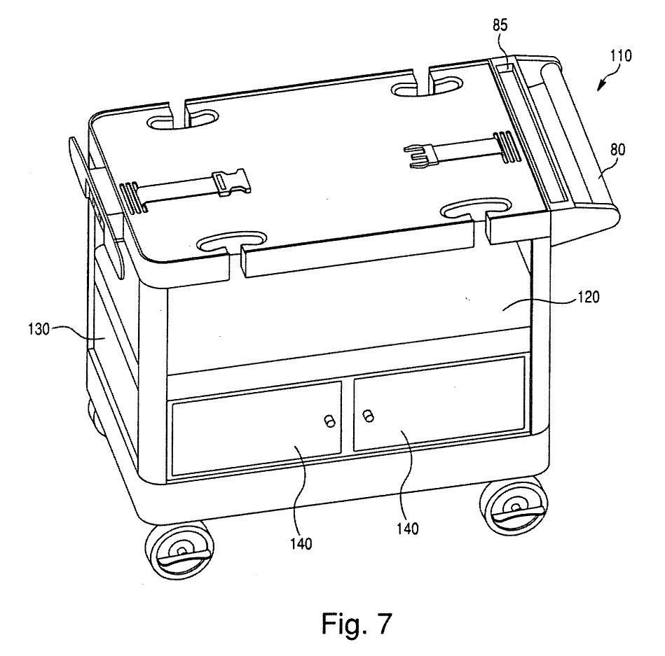

A second embodiment of a cart 110 according to the present invention is shown in FIG. 7. This cart 110 is similar in many respects to the cart 10 of the first embodiment. This cart 110 of the second embodiment, however, includes a shelf 120, walls 130 (only one of the three walls is shown), and doors 140 that form a compartment for storing items.

Other embodiments of the invention will be apparent to those skilled in the art from consideration of the specification and practice of the invention disclosed herein. It is intended that the specification and examples be considered as exemplary only.

1. A cart for an electronic device, the cart comprising:
a platform configured to support an electronic device; and
a cord-retaining portion configured to retain a power cord of the electronic device, wherein the cord-retaining portion includes a first opening that extends in a first direction substantially toward a mid-portion of the cart and a second opening that extends away from the first opening in a second direction that is different from the first direction.

2. The cart of claim 1, wherein the first opening is a first slot having a length and a width, and the length of the first slot is approximately the same as the width of the first slot.

3. The cart of claim 2, wherein the second opening is a second slot having a length and a width, and the length of the second slot is greater than the width of the second slot.

4. The cart of claim 1, wherein the second direction is substantially perpendicular to the first direction.

5. The cart of claim 1, further comprising a third opening that extends away from the first opening in a third direction that is different from the first direction.

6. The cart of claim 5, wherein the third direction is substantially opposite to the second direction.

7. The cart of claim 5, wherein the third direction is substantially perpendicular to the first direction.

8. The cart of claim 5, wherein the first opening has a width and a distance from a side of the second opening to a side of the third opening is greater than the width of the first opening.

9. The cart of claim 8, wherein the distance is at least two times greater than the width of the first opening.

10. The cart of claim 1, wherein the cord-retaining portion is an integral part of the platform.

11. The cart of claim 1, further comprising a support that at least partially supports the platform.

12. The cart of claim 1, further comprising rolling members that at least partially moveably support the platform.

13. The cart of claim 1, further comprising a power strip and a cord-wrapping portion, wherein the power strip includes a power cord and the cord-wrapping portion is disposed about the power strip and is configured to retain the power cord when the power cord is wrapped about the cord-wrapping portion.

14. The cart of claim 1, further comprising a restraint for inhibiting movement of an electronic device disposed on the platform.

15. The cart of claim 14, wherein the restraint includes a strap.

16. The cart of claim 1, further comprising a tray slidably mounted to extend from the platform.

17. The cart of claim 1, further comprising a cord-wrapping portion disposed adjacent the first opening, wherein the cord-wrapping portion is configured to retain a power cord wrapped about the cord-wrapping portion.
